(19) United States
(12) Patent Application Publication
(10) Pub. No.: US 2025/0011001 A1
(43) Pub. Date: Jan. 9, 2025

(54) IMPELLER MACHINE AND METHOD FOR OPERATING AN IMPELLER MACHINE

(71) Applicant: MDGROUP GERMANY GMBH, Siegen (DE)

(72) Inventor: Daniel Schübeler, Delbrück (DE)

(21) Appl. No.: 18/706,639

(22) PCT Filed: Nov. 3, 2022
(86) PCT No.: PCT/EP2022/080722

§ 371 Date: May 1, 2024

(30) Foreign Application Priority Data
Nov. 3, 2021 (EP) 21206247.5

(51) Int. Cl. B64D 33/08; B64C 11/00; F04D 25/06; F04D 29/58

(52) U.S. Cl. CPC B64D 33/08; B64C 11/001; F04D 25/0606; F04D 29/5806

(57) ABSTRACT

The invention relates to an impeller machine with an aero rotor (14) for generating an air flow along an annular space (31) enclosed between an impeller housing (15) and a motor housing (19). The motor housing (19) is arranged in an inner chamber of the impeller housing (15), and an electric motor (16) is arranged in the interior of the motor housing (19). The electric motor (16) comprises a motor stator (44), which is connected to the motor housing (19), and a magnetic rotor (43), which is connected to the aero rotor (14). A cooling air channel (40) extends in the interior of the motor housing (19) between an inlet end (33) and an outlet end (35), and a liquid channel (46) has an opening (47) which is arranged in a cooling air channel (40) suction arranged upstream of the electric motor (16). The invention also relates to a method for operating an impeller machine.

### BACKGROUND

The invention relates to an impeller machine and a method for operating an impeller machine. The impeller machine comprises an aero rotor for generating an air flow along an annular space which is enclosed between an impeller housing and a motor housing. The motor housing is arranged in an inner space of the impeller housing. An electric motor is arranged in an inner space of the motor housing, wherein the electric motor comprises a motor stator which is connected to the motor housing and a magnetic rotor which is connected to the aero rotor.

During operation of an impeller machine, heat is generated to a substantial extent. If, for example, from 5% to 10% of the drive power is converted to heat in an impeller machine having a power in the order of magnitude of a few kilowatt, overheating of components of the impeller may occur if the heat is not discharged adequately.

An object of the invention is to provide an impeller having improved thermal discharge. The object is achieved with the features of the independent claim. Advantageous embodiments are set out in the dependent claims.

The impeller machine according to the invention comprises a cooling air channel which extends in the inner space of the motor housing between an inlet end and an outlet end. The impeller machine comprises a liquid channel having an opening which is arranged in a portion, which is arranged upstream of the electric motor, of the cooling air channel.

### SUMMARY

The invention is based on the notion of using the evaporation energy of a liquid to cool the electric motor. By a cooling air flow which is supplied to the electric motor being displaced with a liquid upstream of the electric motor, there is supplied to the electric motor a liquid medium which can completely or partially evaporate while absorbing thermal energy from components of the electric motor. It has been found that a combination of the air cooling by the cooling air flow and the evaporation cooling by a liquid medium which is supplied with the cooling air flow allows a very effective cooling of components of the electric motor.

An impeller machine according to the invention is an axial flow machine. The air flow which is driven with the aero rotor has a flow direction which is parallel with the axis of the aero rotor. The aero rotor has rotor blades which are arranged in the same radial portion, with respect to the axis, as the annular space which is arranged between the impeller housing and the motor housing.

The difference between impeller machines and other types of flow machines is brought about on the basis of the Cordier diagram which is shown in FIG. 11 and in which the speed number σ is indicated against the diameter number δ. The impeller machines according to the invention differ from radial and flow machines as a result of a higher value for the speed number σ and by a lower value for the diameter number δ. The impeller machines according to the invention differ from propeller machines without coverings as a result of a lower value for the speed number σ and a higher value for the diameter number δ. The speed number σ of the impeller machine according to the invention may be between 1.8 and 10. The diameter number δ of the impeller machine according to the invention may be between 0.8 and 1.5.

The speed number σ used in the Cordier diagram is a dimensionless characteristic number which is defined as follows.

$$σ = 2 \sqrt{π} n \frac{\sqrt{Q}}{{( 2 Y )}^{3 / 2}}$$

The diameter number δ is also a dimensionless characteristic number which is defined as follows.

$$δ = \frac{\sqrt{π}}{2} D \sqrt[4]{\frac{2 Y}{{Q}^{2}}}$$

Both formulae take into consideration the volume flow Q and the specific head Y. If these two variables are considered to be predetermined by the intended use of the flow machine, the speed number σ is still dependent only on the speed n and the diameter number δ is still dependent only on the diameter D of the aero rotor. More detailed explanations of this appear, for example, in Epple et al., A theoretical derivation of the Cordier diagram for turbomachines, Proceedings of the Institution of Mechanical Engineers, Part C: Journal of Mechanical Engineering Science 2011 225:354.

The annular space which is enclosed between the impeller housing and the motor housing has, when viewed in an axial direction, a front end and a rear end, wherein the flow direction of the air flow which is driven by the aero rotor is directed from the front end toward the rear end. The indications front and rear are direction indications which relate in this context to the axial direction of the impeller machine.

The inlet end of the cooling air channel may be arranged in a region in which during operation of the impeller machine a higher pressure is applied than at the outlet end. In this manner, the cooling air flow can be driven through the cooling air channel by the pressure difference. The inlet end of the cooling air channel can have a greater spacing from the front end of the impeller machine than the outlet end of the cooling air channel. The direction of the cooling air flow in the cooling air channel then has a component which is directed counter to the flow direction of the air flow in the annular space.

The inlet end of the cooling air channel may be arranged in a position which is located behind the rear end of the annular space. In one embodiment, the inlet end of the cooling air channel at the rear end of the motor housing is formed concentrically with respect to the axis of the impeller machine. A concentric arrangement of the inlet end has the advantage that a concentric propagation of the cooling air flow inside the motor housing can be promoted.

In the region of the electric motor, the cooling air channel can be guided through an annular gap between the magnetic rotor and the motor stator. In particular, the cooling air channel can extend radially inside the motor stator and radially outside the magnetic rotor. In this case, there may be produced an intimate flow-around of the electric or magnetic components of the electric motor so that the resultant heat is effectively discharged. According to the invention, the portion of the cooling air channel between the electric motor and the inlet end is located upstream.

The opening of the liquid channel can be arranged with axial spacing from the annular motor gap which is enclosed between the magnetic rotor and the motor stator. The axial spacing is preferably no less than 20%, more preferably no less than 50%, more preferably no less than 100% of the radius of the aero rotor. With respect to the length of the annular motor gap, the axial spacing is preferably no less than 20%, more preferably no less than 50%, more preferably no less than 100%. The length of the annular motor gap corresponds to the axial portion of the impeller machine in which the magnetic rotor and the motor stator interact with each other electromagnetically. If the liquid is supplied to the cooling air channel with an axial spacing from the motor, the liquid can be radially distributed within the path to be travelled so that the motor is cooled over its circumference in a uniform manner.

For the uniform distribution of the cooling action over the circumference of the motor, it is further advantageous if the opening of the liquid channel is arranged radially inside the annular motor gap. In other words, the spacing between the axis of the impeller machine and the opening of the liquid channel is smaller than the radius of the inner face of the motor stator. In particular, the spacing between the axis of the impeller machine and the opening of the liquid channel can be less than 80%, preferably less than 50% of the radius of the inner face of the motor stator.

In the axial portion between the opening of the liquid channel and the annular motor gap, there may be formed a guiding face along which the liquid which is discharged from the liquid channel is directed to the motor. The guiding face may be rotationally symmetrical and concentric with respect to the axis of the impeller machine. The contour of the guiding face may be smooth, that is to say, free from shoulders and edges so that an air flow is directed in the direction of the annular motor gap in a manner which is free from turbulence as far as possible. The guiding face can be arranged radially inside the annular motor gap. In one embodiment, the liquid is directed to the annular motor gap between a first guiding face which is arranged radially inside the annular motor gap and a second guiding face which is arranged radially outside the annular motor gap.

The opening of the liquid channel can be arranged near the inlet end of the cooling air channel. It is advantageous if the cooling air channel has an outlet end which is arranged further forward than the electric motor so that the cooling air can flow around the electric motor over the entire length thereof. The outlet end can open in the annular space so that the liquid which is discharged from the liquid channel can be distributed in the cooling air flow. It is advantageous to this end for the liquid quantities to be introduced into the cooling air flow in a finely distributed form. To this end, the opening of the liquid channel can be provided with a nozzle so that the liquid is discharged from the liquid channel in a finely distributed state. It is also possible to achieve a fine distribution of the liquid simply by the cooling air flow flowing past the opening of the liquid channel at a high speed.

The liquid channel may have a portion which intersects with the cooling air flow which therefore extends through the cross section of the cooling air channel. The cooling air flow then sweeps along the outer face of the liquid channel at both sides. Openings in the wall of the liquid channel can be in the form of an opening of the liquid channel. The openings may be directed in the direction in which the cooling air flow moves. In this manner, a good distribution of the liquid in the cooling air flow can be achieved.

Quantities of liquid contained in the cooling air flow can evaporate by absorbing heat from the electric and magnetic components of the motor and can be discharged into the annular space together with the cooling air flow. During this operation, the liquid is lost. The invention also includes embodiments in which the liquid is condensed downstream of the electric motor and recovered.

The aero rotor can be arranged at a front end of the impeller machine and therefore in a position in front of the magnetic rotor of the electric motor. A portion, which is arranged between the aero rotor and the rear end of the annular space, of the annular space may form at least 50%, preferably at least 70%, more preferably at least 80% of the axial length of the annular space. A portion of the impeller housing can extend around the outer circumference of the aero rotor. The aero rotor may have a rotor hub and a plurality of rotor blades which are fitted to the rotor hub. The rotor hub can be connected to a shaft of the impeller machine which is driven by the motor.

The impeller machine may comprise one or more aero stators which extend between the inner side of the impeller housing and the outer side of the motor housing and which retain the impeller housing and the motor housing in a fixed position relative to each other. The impeller machine may comprise more than two aero stators, for example, three or five aero stators. The aero stators may be arranged in a manner identically distributed over the circumference of the motor housing.

The aero stators may form a profile which is bent in a flow direction. The profile may be configured in such a manner that the rotation component, which is generated with the aero rotor, of the air flow is absorbed and directed in a longitudinal direction. In particular, the aero stators can define a wing profile, which is flowed around by the air flow and which has a pressure side and a suction side. During operation of the impeller machine, the pressure applied at the pressure side is higher than the pressure applied at the suction side.

A portion, which is located downstream of the electric motor, of the cooling air channel can be guided outwardly through the motor housing. In one embodiment, the outlet end of the cooling air channel is arranged in the motor housing so that the cooling air flow is discharged from the cooling air channel directly after passing the motor housing and is joined with the air flow in the annular space. It is also possible for the cooling air channel to be guided through the motor housing into the inner space of an aero stator. The wall of the aero stator can have an opening which forms the outlet end of the cooling air channel and through which the cooling air flow can be discharged into the annular space. The outlet end can be arranged on the suction side of the aero stator which forms a wing profile.

It may be advantageous, for uniform distribution of the cooling air flow over the circumference of the electric motor, for the cooling air flow to be divided by the cooling air channel comprising a plurality of paths, via which the cooling air flow can be discharged from the inner space of the motor housing into the annular space. For example, the cooling air flow can have a plurality of openings, which are distributed over the circumference of the motor housing, in the direction toward the annular space. In one embodiment, the cooling air channel extends through the inner space of a plurality of aero stators, preferably through the inner space of all the aero stators. Each of the aero stators which form a portion of the cooling air channel can have an opening which is arranged on the suction side in the direction toward the annular space, which opening corresponds to an outlet end of the cooling air channel.

The annular space which is enclosed between the impeller housing and the motor housing may have a portion with a constant cross section. The portion may extend over at least 50%, preferably at least 70%, more preferably at least 80% of the axial length of the annular space. The term “constant cross section” means that the spacing between the inner side of the impeller housing and the outer side of the motor housing is constant and the outer diameter and inner diameter of the annular space are constant. Aero stators and/or cooling structures within the annular space are not considered to be a change to the cross section in this sense. The aero rotor may have rotor blades which cover the constant cross section of the annular space when viewed in a radial direction of the impeller machine.

The impeller machine may comprise a liquid store, from which the liquid is supplied to the liquid channel. The liquid store can be contained in a tank which is connected to the liquid channel so that the liquid can be guided out of the tank through the liquid channel to the cooling air channel. For example, water, particularly distilled water, can be used as the liquid. Other liquids, such as, for example, alcohol or oils, are also possible.

The inner space of the tank can be pressurized in order to drive the movement of the liquid through the liquid channel. The pressure can, for example, be supplied in that the tank itself forms a pressure reservoir or the tank is connected to a pressure reservoir. In one embodiment, the pressure is taken from the air flow which is generated by the aero rotor. To this end, the impeller machine may comprise a pressure line which extends between the inner space of the tank and a region of the annular space, in which the air flow has a high pressure.

The pressure line can extend through the inner space of an aero stator and can be connected to the annular space by an inlet opening in the wall of the aero stator. The inlet opening may, for example, be arranged at the pressure side of an aero stator which is in the form of a wing profile. For particularly high pressure in the pressure line, the inlet opening can be arranged in a front face of the aero stator, which the air flow strikes frontally before it is separated between the suction side and the pressure side. If an aero stator has both an inlet opening for the pressure line and an outlet opening of the cooling air channel, a partition wall which separates the two regions from each other can be arranged inside the aero stator.

It is possible during operation of the impeller machine to continuously allow liquid to be discharged from the opening of the liquid channel. This may be advantageous when the impeller machine is operated continuously at high power. In practical application, however, it is often the case that there is a change between operating phases at high power and operating phases at low power. It is desirable to make use of the additional evaporation cooling only when the normal cooling air flow does not absorb heat to a sufficient extent. For this reason, the impeller machine can be configured so that it is possible to switch between a first operating state, in which liquid is discharged from the liquid channel, and a second operating state, in which no liquid is discharged from the liquid channel. Additionally or alternatively, the impeller machine can be configured so that the quantity of liquid being discharged is adjustable.

The impeller machine may have a valve which is arranged in the liquid channel and which, under the control of a control unit of the impeller machine, can be switched between an open state and a closed state. The valve can be switched in such a manner that in the open state the liquid quantity is variably adjustable. The valve can be arranged in the liquid line between the liquid store and the cooling air channel. The control unit can control the valve in accordance with an input variable, such as, for example, the current power of the impeller machine or the temperature of a component of the impeller machine.

A covering component can be arranged behind the motor housing. The outer face of the covering component can terminate flush with the motor housing. In the direction toward the rear end, the covering component can taper so that the air flow from the annular space downstream of the impeller machine is combined to form a closed air flow.

The covering component may comprise an inner covering which forms the outer wall of the cooling air channel. The rear end of the inner covering can surround the inlet end of the cooling air channel. The diameter of the inner covering can expand in the direction toward the front end of the covering component.

A hollow space can be formed between the outer wall of the covering component and the inner covering. A portion of the liquid channel can extend inside the hollow space. An end of the liquid channel can be connected to an opening in the inner covering and can therefore form the opening of the liquid channel.

The liquid channel can extend through an opening in the outer wall of the covering component. The liquid channel can be guided in a winding around the inner covering between the outer wall of the covering component and the opening thereof. The winding can extend over at least 180°, preferably at least 360°. The valve with which the liquid supply to the cooling air channel is controlled can be arranged between the position, in which the liquid channel passes through the outer wall of the covering component, and the opening. The valve can be connected to the outer wall of the covering component.

The liquid channel may comprise a portion in which the liquid channel is formed by a flexible hose. In one embodiment, a flexible hose forms at least 50%, preferably at least 80% of the length of the liquid channel between the liquid store and the opening.

In order to further improve the heat discharge, the outer side of the motor housing can be provided with a plurality of cooling ribs. The cooling ribs can be adapted in a longitudinal direction to the extent of the air flow in the annular space. To this end, the cooling ribs may have the features mentioned below individually or in combination. A front portion of the cooling ribs can be arranged in a different circumferential position from that of a rear portion of the cooling ribs. The circumferential position of the cooling rib can change continuously with the extent of the cooling rib. The cooling rib can extend in an axial direction over at least 60%, preferably at least 80%, more preferably at least 90% of the length of the motor housing. In this context, the component which surrounds the motor is referred to as the motor housing. The extent of the cooling rib along the outer side of the motor housing can be a non-linear extent. A front portion of the cooling ribs can define a greater angle with the longitudinal direction than a rear portion of the cooling ribs. The front end of the cooling rib can define an angle of more than 10°, for example, an angle between 10° and 50°, preferably an angle between 20° and 40°, with the longitudinal direction. The rear end of the cooling rib can define an angle less than 8°, preferably an angle less than 5° with the longitudinal direction. The cooling rib may have a continuous curvature. The curvature may be configured so that the angle between the cooling rib and the longitudinal direction becomes smaller continuously from the front end to the rear end of the cooling rib.

In a radial direction, the cooling rib can extend from the outer side of the motor housing as far as a peripheral end, wherein the peripheral end is arranged within the annular space and has a spacing from the inner wall of the impeller housing. The height of the cooling rib corresponds to the spacing between the bottom of the cooling rib and the peripheral end of the cooling rib. The height of the cooling rib above the outer side of the motor housing may be between 2% and 20%, preferably between 5% and 15% with respect to the diameter of the motor housing. With respect to the radial extent of the annular space between the inner side of the impeller housing and the outer side of the motor housing, the height of the cooling rib may be between 2% and 20%, preferably between 5% and 15%. With a greater height of the cooling rib, although the cooling action could possibly be further improved, the cooling rib also acts counter to the air flow with a resistance so that, with a greater height of the cooling rib, the degree of efficiency of the impeller would also decrease. If the diameter of the motor housing changes over the length of the impeller, the indication relates to the greatest diameter of the motor housing. If the radial extent of the annular space changes over the length of the impeller, the indication relates to the greatest radial extent of the annular space. The cooling rib can have a constant height over the length thereof. If the height of the cooling rib changes over the length of the impeller, the indication relates to the greatest height of the cooling rib.

The air flow driven with the aero rotor through the annular space has a component in an axial direction and a component in a circumferential direction. The front end of the cooling rib can be orientated in such a manner that the air flow is introduced into the annular space substantially parallel with the end of the cooling rib. The cooling rib can contribute, with the shape thereof bent along the annular space, to guiding the air flow so that it is directed substantially in an axial direction during discharge from the annular space. The rotor which is arranged in front of the motor housing can be arranged inside the impeller housing.

The rear end of the motor housing can project backward beyond the rear end of the impeller housing. The cooling rib may comprise a rear portion which is located outside the annular space which is surrounded by the impeller housing. This has the advantage that the air flow in the region of the motor housing is also still subjected to guiding during the transition from the annular space to the environment.

The cooling ribs can be distributed over the circumference of the motor housing and can be formed in a corresponding manner. Two cooling ribs are formed in a corresponding manner when they can be mapped in each other by a rotation of the impeller machine about its axis. The lateral spacing between two cooling ribs can be between 25% and 200% of the height of the cooling ribs. A plurality of cooling ribs can be arranged between two adjacent aero stators, for example, at least three cooling ribs, preferably at least five cooling ribs, more preferably at least eight cooling ribs. This may apply to each pair of adjacent stators.

The invention also relates to an aircraft, the drive of which comprises such an impeller machine. It may involve an aircraft which takes off vertically. The aircraft can be configured so that the impeller machine during take-off or landing generates a drive force which acts in a vertical direction. The aircraft can additionally or alternatively be configured so that, during forward flight, the impeller machine generates a drive force which acts in a horizontal direction. In order to be able to generate drive forces in different directions, the impeller machine can be connected to a frame of the aircraft in a pivotable manner. The aircraft can be provided with a plurality of impeller machines. Each of the impeller machines can have the mentioned features individually or in combination.

There are other application areas for impeller machines according to the invention, such as, for example, generating an air flow for cooling a battery, generating an air flow for influencing the aerodynamic relationships on the wing of an aircraft or generating an air flow for applying drive forces in self-controlled robots.

The invention further relates to a method for operating an impeller machine. In the method, an air flow is generated with an aero rotor along an annular space which is enclosed between an impeller housing and a motor housing. An electric motor which is arranged in an inner space of the motor housing is cooled by a cooling air flow being directed through a cooling air channel which extends in the inner space of the motor housing between an inlet end and an outlet end. A liquid is supplied to a portion, which is arranged upstream of the electric motor, of the cooling air channel. As a result, it becomes possible to cool the electric motor effectively by way of evaporation cooling.

The method can be developed with additional features which are described in connection with the impeller machine according to the invention. The impeller machine can be developed with additional features which are described in connection with the method according to the invention.

### BRIEF DESCRIPTION OF THE DRAWINGS

The invention is described below with reference to the appended

FIG. 1: shows an aircraft according to the invention;

FIG. 2: shows an embodiment of an impeller machine according to the invention;

FIGS. 3-5: show additional views of the impeller machine from FIG. 2;

FIGS. 6-8: show details of the impeller machine from FIG. 2 as an enlarged illustration;

FIG. 9: shows a schematic illustration of a cooling rib of an impeller according to the invention;

FIG. 10: shows a simplified sectioned illustration of a motor housing according to the invention;

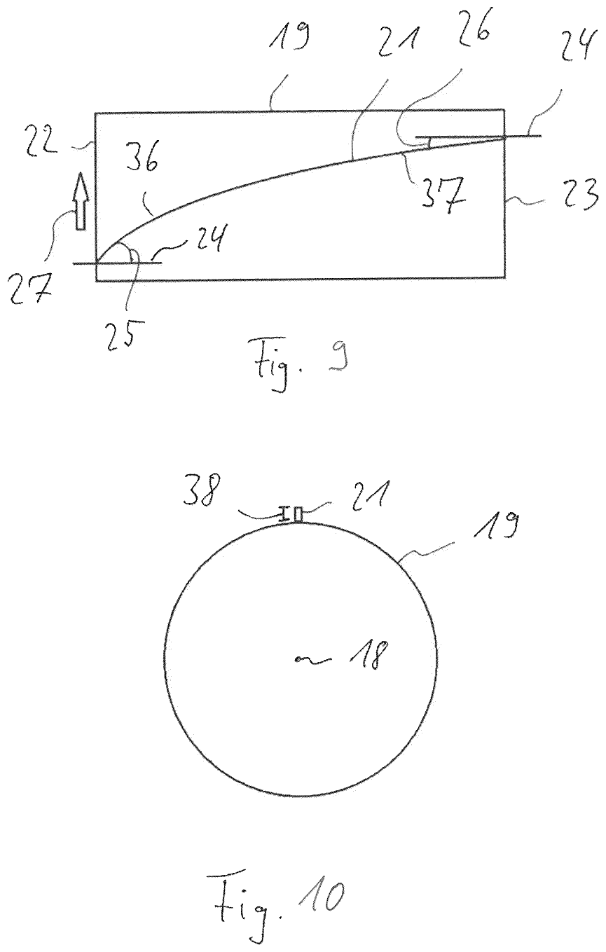

FIG. 11: shows a Cordier diagram for distinguishing different types of flow machines.

### DETAILED DESCRIPTION

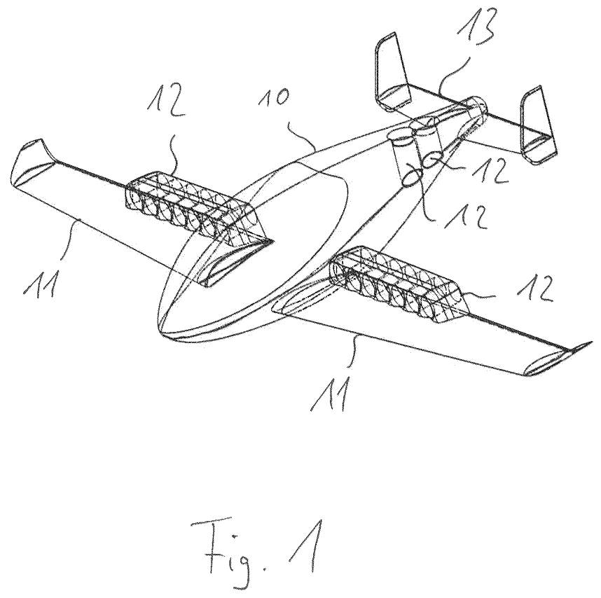

FIG. 1 shows an aircraft according to the invention which has a fuselage member 10 which is suitable for transporting a number of persons. Two wings 11 which are supported in a pivotable manner about a horizontal axis relative to the fuselage member 10 are connected to the fuselage member 10. At the rear end of the fuselage member 10, a tail unit 13 is formed.

The fuselage member 10 is provided with two impeller machines 12 which act in a vertical direction. At the upper side of each of the wings, a housing in which seven impeller machines 12 are arranged is formed.

During the take-off of the aircraft, the wings 11 are pivoted relative to the fuselage member 10 so that the impeller machines 12 which are connected to the wings 11 act in a vertical direction and the aircraft can take off in a vertical direction. After reaching an adequate flight height, the wings 11 are pivoted into the position shown in FIG. 1 in order to allow forward flight of the aircraft.

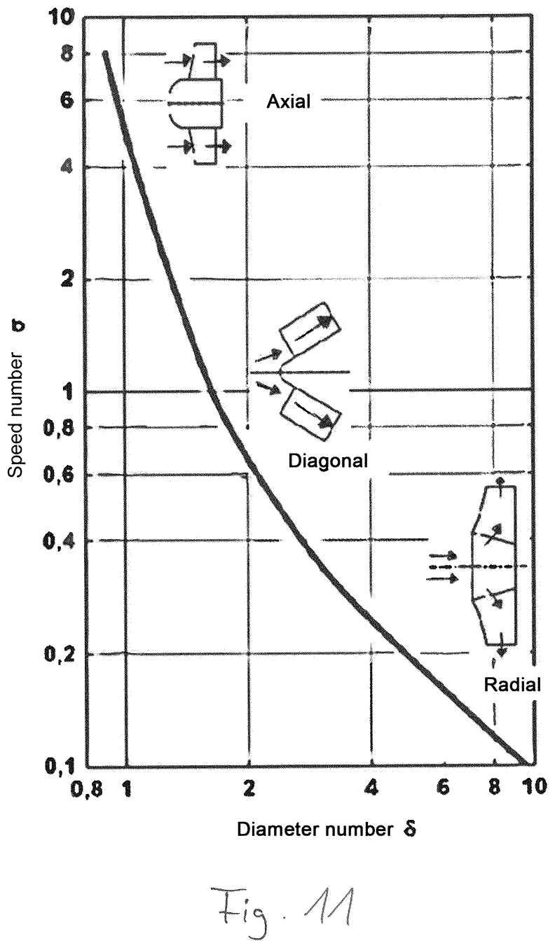

An impeller machine according to the invention is an axial flow machine having a high degree of efficiency which has in the Cordier diagram (FIG. 11) a speed number σ between 1.8 and 10 and a diameter number δ between 0.8 and 1.5. The impeller machine according to the invention differs from radial flow machines with a high degree of efficiency as a result of a higher value for the speed number σ and a lower value for the diameter number δ. The impeller machine according to the invention differs from propeller machines without coverings as a result of a lower value for the speed number σ and a higher value for the diameter number δ.

According to FIG. 4, an impeller machine according to the invention comprises an aero rotor 14 which is arranged in an impeller housing 15. An electric motor 16 drives a shaft 17 so that the aero rotor 14 which is connected to the shaft 17 is caused to rotate. The shaft 17 extends along a center axis 18 of the impeller machine. The longitudinal direction of the impeller machine is parallel with the center axis 18. The motor 16 is retained in a motor housing 19 which is arranged in the inner space of the impeller housing 15.

In an annular space 31 which is enclosed radially outside the motor housing 19 and radially inside the impeller housing 15, there are formed a plurality of aero stators 20 with which the motor housing 19 is fixed in position relative to the impeller housing 15. The aero rotor 14 comprises a plurality of rotor blades 21 which extend around at a front end of the annular space 31. By rotating the aero rotor 14, an air flow which extends from the aero rotor 14 through the annular space 31 as far as the opposite, rear end of the impeller machine is generated. The front end of the impeller machine corresponds, with respect to the air flow in the annular space 31, to the upstream end, the downstream end is the rear end of the impeller machine.

The front end of the impeller housing 15 is located further upstream than the front end of the motor housing 19. The impeller housing 15 surrounds the rotor 14 which is arranged in front of the motor housing 19 so that the rotor rotates in the inner space of the impeller housing 15.

The rear end of the motor housing 19 is located further downstream than the rear end of the impeller housing 29. The motor housing 19 thereby comprises a rear portion which projects backward beyond the impeller housing 15.

At the outer side of the motor housing 19, there are formed cooling ribs 21 which extend in a longitudinal direction between the front end and the rear end of the motor housing 19. The air flow in the annular space 31 sweeps over the surface of the cooling ribs 21 and guides heat away from cooling ribs 21. The heat which is discharged by the rotor during operation of the impeller machine propagates through the motor housing 19 to the cooling ribs 21 and is taken up by the air flow at that location.

A plurality of cooling ribs 21 are formed between two adjacent aero stators 20. The cooling ribs 21 are formed identically and have a constant spacing from each other so that a cooling channel, which is open toward one side and which has a substantially constant cross section, extends between two cooling ribs 21. The air flow can follow the air channels without great occurrences of turbulence being produced.

When viewed in the longitudinal direction, a greater portion of the cooling ribs 21 is arranged inside the annular space 31 between the impeller housing 15 and the motor housing 19. A shorter portion of the cooling ribs 21 projects backward out of the annular space 31. The cooling ribs 21 terminate with the rear end of the motor housing 19. A covering component 30, with which the motor is covered in a backward direction, adjoins the rear end of the motor housing 19.

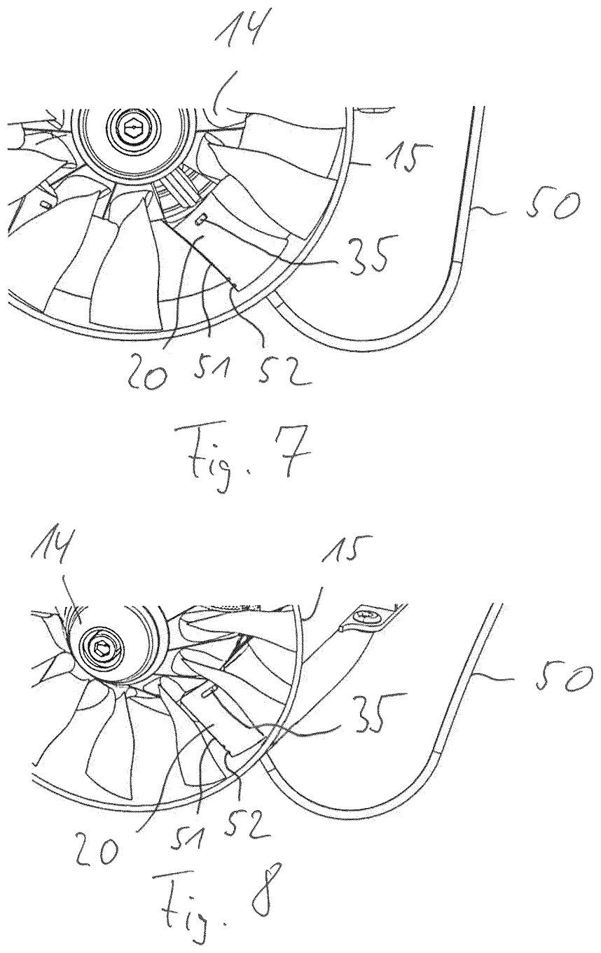

The cooling ribs 21 extend in a longitudinal direction along a curved path from the front end 22 to the rear end 23 of the motor housing 19. The longitudinal direction of the cooling rib 21 defines an angle 25 of approximately 45° with the longitudinal direction 24 according to the schematic illustration in FIG. 9 at the front end 22 of the motor housing 19. The angle between the cooling rib 21 and the longitudinal direction 24 becomes continuously smaller with increasing spacing from the front end 22 of the motor housing 19. At the rear end 23 of the motor housing 19, the angle 26 between the longitudinal direction of the cooling rib 21 and the longitudinal line 24 is still approximately 5°.

The arrow 27 shows the rotation direction with which the rotor 14 passes this circumferential portion of the motor housing 19. The angle between the longitudinal direction of the cooling rib 21 at the front end 22 of the motor housing 19 and the movement direction of an adjacent portion of the rotor 14 is less than 90°.

When viewed in cross section, the cooling ribs 21 according to the schematic illustration in FIG. 4 are substantially rectangular. The cooling ribs 21 have a cross section which is substantially constant over the length thereof. The cooling ribs 21 define a right-angle with the surface of the motor housing 19.

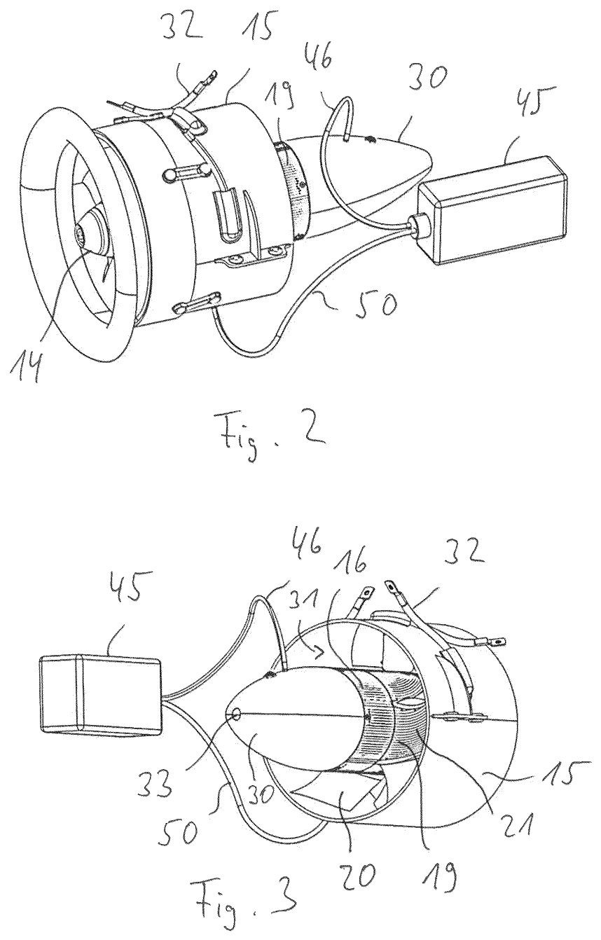

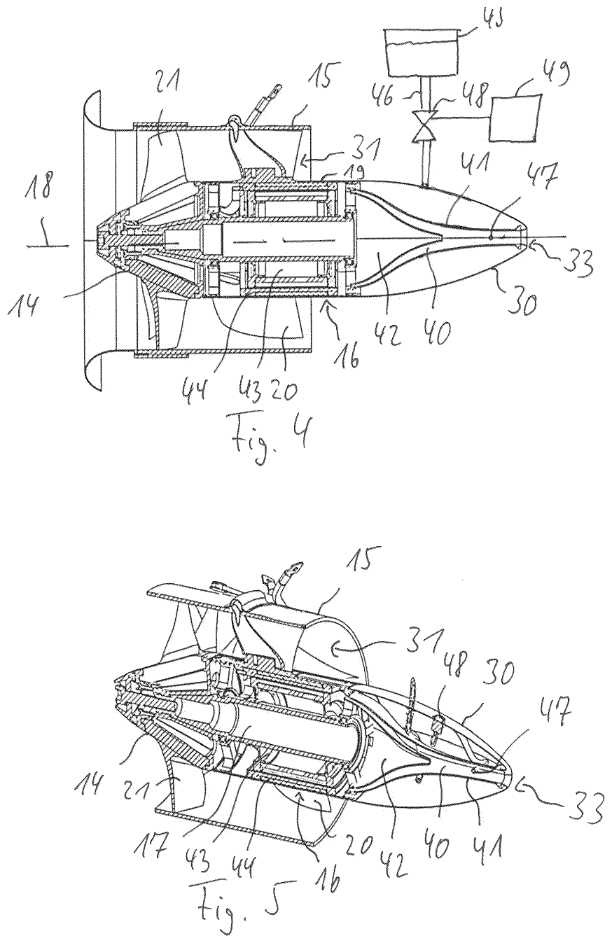

In the embodiment according to FIGS. 2 to 5, the aero stators 20 have internally a hollow space which extends over the entire radial extent of the annular space 31. Cables 32 which extend from the inner space of the motor housing 19 to the outer space of the impeller housing 15 are guided in the hollow space. The cables 32 comprise supply lines, with which electrical energy is supplied from a battery, which is arranged outside the impeller, to the electric motor 16 in the motor housing 19. The cables 32 can further comprise control lines and/or sensor lines, via which signals are transmitted during operation of the impeller machine. At the rear end of the motor housing 19, there is arranged a control circuit board via which the motor 16 is controlled. By the cables 32 being guided inside the aero stators 20, it is possible to avoid the air flow being impaired between the cooling ribs 21 by cables.

A covering component 30 which is arranged at the rear end of the impeller machine is provided with an inlet opening 33 of a cooling air channel 40. The cooling air channel 40 extends from the inlet opening 33 through the inner space of the motor housing 19 as far as an outlet opening 35 which opens in the annular space 31. The outlet opening 35 extends through the wall of the motor housing 19 and is arranged in a region in which a reduced pressure is applied during operation of the impeller machine 19.

In the embodiment according to FIG. 2, the outlet opening 35 of the cooling air channel 40 is arranged at the suction side of an aero stator 20. The outlet opening 35 which is formed in the wall of the aero stator 20 is connected to a hollow space inside the aero stator 20 which is itself connected to the inner space of the motor housing 19. If a reduced pressure is applied at the outlet opening 35 while in the region of the inlet opening 33 substantially atmospheric pressure is applied, during operation of the impeller machine a cooling air flow through the cooling air channel 40 is generated by the pressure difference.

For effective inner cooling of the electric motor 16, the cooling air channel 40 has a plurality of outlet openings 35. An outlet opening 35 is associated with each of the three aero stators 20, wherein the outlet opening 35 is arranged at the suction side of the aero stator 20. The introduction of the cooling air at the rear end of the impeller machine is carried out via the inlet opening 33 which is concentric with respect to the center axis 18.

Starting from the inlet opening 33, the outer wall of the cooling air channel 40 is formed by an inner covering 41 of the covering component 30. The inner covering 41 expands in the direction toward the motor 16 so that the cooling air flow is supplied to the peripheral region of the motor 16. Inside the cooling air channel 40, there is arranged a core component 42 which also expands in the direction toward the motor 16 so that the cooling air flow is guided in an annular portion, which is arranged around the core component 42, of the cooling air channel 40. From that location, the cooling air channel 40 continues through an annular gap between the magnetic rotor 43 and the motor stator 44 of the electric motor 16 as far as the outlet openings 35. After passing through the outlet openings 35, the cooling air flow joins the air flow in the annular space 31. The core component 42 forms a first guiding face according to the invention. The inner covering 41 forms a second guiding face according to the invention.

The impeller machine comprises a tank 45 which is filled with distilled water and which is connected to the cooling air channel 40 via a liquid line 46. The opening 47 of the liquid channel 46 is arranged between the inlet end 33 of the cooling air channel 40 and the motor 16 and therefore in a portion, which is located upstream, of the cooling air channel 40. The liquid channel 46 is provided with a switchable valve 48 which either releases or closes the path from the tank 45 to the opening 47 of the liquid channel 46. The valve 48 is controlled via control signals by a control unit 49.

The liquid in the tank 45 is pressurized so that, when the valve 48 is open, liquid is discharged from the opening 47 and is supplied to the cooling air flow in the cooling air channel 40. The liquid is divided into fine drops and is supplied with the cooling air flow to the magnetic rotor 43 and the motor stator 44 of the motor 16, where the liquid is at least partially evaporated and absorbs heat in this instance. After being discharged from the cooling air channel 40, the vapor is discharged with the air flow in the annular space 31 and is lost. The tank 45 has to be filled up with new liquid regularly.

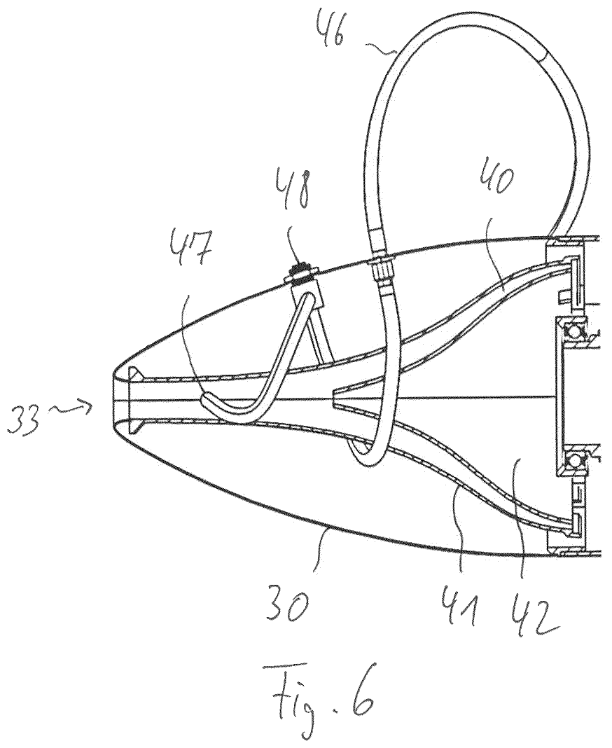

In the embodiment according to FIG. 6, the liquid channel 46 is in the form of a flexible hose 46 between the tank 45 and the cooling air channel 40. The liquid channel 46 is guided through the outer wall of the covering component 30 and extends inside a hollow space between the outer wall and the inner covering 41 to the valve 48, see FIG. 6. From that location, it travels onward to the opening 47 of the liquid channel 46.

The excess pressure in the tank 45 is generated via a pressure line 50 which is connected to the tank 45 and the other end of which opens in the annular space 31 as an inlet opening 52. According to FIG. 7, the pressure line 50 is guided through the impeller housing 15 into the inner space of an aero stator 20. The aero stator 20 has at the front side 51 thereof two inlet openings 52 by which the pressure line 50 is supplied. The air flow which is generated with the aero rotor 15 frontally strikes the front side 51 of the aero stator 20 and thereby generates the desired excess pressure.

In the inner space of the aero stator 20, there is arranged a partition wall with which the excess pressure which is introduced through the inlet openings 52 of the pressure line 50 is separated from the reduced pressure which is applied at the outlet opening 35 of the air channel 40.

1. An impeller machine having an aero rotor (14) for generating an air flow along an annular space (31) which is enclosed between an impeller housing (15) and a motor housing (19), wherein the motor housing (19) is arranged in an inner space of the impeller housing (15), wherein an electric motor (16) is arranged in an inner space of the motor housing (19), wherein the electric motor (16) comprises a motor stator (44) which is connected to the motor housing (19) and a magnetic rotor (43) which is connected to the aero rotor (14), wherein an annular motor gap is formed between the motor stator (44) and the magnetic rotor (43), having a cooling air channel (40) which extends in the inner space of the motor housing (19) between an inlet end (33) and an outlet end (35), and having a liquid channel (46), wherein the liquid channel (46) has an opening (47) which is arranged in a portion, which is arranged upstream of the electric motor (16), of the cooling air channel (40).

2. The impeller machine of claim 1, wherein the opening (47) of the liquid channel (46) is arranged radially inside the annular motor gap.

3. The impeller machine of claim 1, wherein radially inside the annular motor gap there is formed a guiding face (42) along which the liquid which is discharged from the liquid channel is directed to the motor (16).

4. The impeller machine of claim 1, wherein a speed number σ of the impeller machine is between 1.8 and 10 and/or in that a diameter number δ of the impeller machine is between 0.8 and 1.5.

5. The impeller machine of claim 1, wherein the inlet end (33) of the cooling air channel (40) is arranged in a region in which during operation of the impeller machine a higher pressure is applied than at the outlet end (35).

6. The impeller machine of claim 1, wherein the motor housing (19) is retained by at least one aero stator (20) relative to the impeller housing (15) and in that the outlet end (35) of the cooling air channel (40) is arranged in a wall of the at least one aero stator (20).

7. The impeller machine of claim 1, wherein having a tank (45) from which the liquid is supplied to the liquid channel (46).

8. The impeller machine of claim 7, wherein an inner space of the tank (45) is under excess pressure during operation of the impeller machine.

9. The impeller machine of claim 8, wherein a pressure line (50) extends between the tank (45) and the annular space (31).

10. The impeller machine of claim 9, wherein the pressure line (50) extends through an inner space of an aero stator (20).

11. The impeller machine of claim 10, wherein the pressure line (50) has an inlet opening (52) which is arranged in a front face (51) of the aero stator (20).

12. The impeller machine of claim 1, wherein there is arranged in the liquid channel (46) a valve (48) which, under the control of a control unit (49), can be switched between an open state and a closed state.

13. The impeller machine of claim 1, wherein a covering component (30) is arranged behind the motor housing (19), wherein the covering component (30) comprises an inner covering (41) and wherein a portion of the liquid channel (46) is arranged in a hollow space between the inner covering (41) and an outer wall of the covering component (30).

14. An aircraft, wherein a drive of the aircraft comprises an impeller machine of claim 1.

15. A method for operating an impeller machine, wherein an air flow is generated with an aero rotor (14) along an annular space (31) which is enclosed between an impeller housing (15) and a motor housing (19), wherein an electric motor (16) which is arranged in an inner space of the motor housing (19) is cooled by a cooling air flow being directed through a cooling air channel (40) which extends in the inner space of the motor housing (19) between an inlet end (33) and an outlet end (35), and wherein a liquid is supplied to a portion, which is arranged upstream of the electric motor (16), of the cooling air channel (40).
